(19) United States
(12) Patent Application Publication
(10) Pub. No.: US 2014/0041040 A1
(43) Pub. Date: Feb. 6, 2014

(54) CREATING SECURE MULTIPARTY COMMUNICATION PRIMITIVES USING TRANSISTOR DELAY QUANTIZATION IN PUBLIC PHYSICALLY UNCLONABLE FUNCTIONS

(71) Applicants: Miodrag Potkonjak, Los Angeles, CA (US); Saro Meguerdichian, West Hills, CA (US)

(72) Inventors: Miodrag Potkonjak, Los Angeles, CA (US); Saro Meguerdichian, West Hills, CA (US)

(73) Assignee: The Regents of the University of California, Oakland, CA (US)

(21) Appl. No.: 13/956,243

(22) Filed: Jul. 31, 2013

Related U.S. Application Data
(60) Provisional application No. 61/680,976, filed on Aug. 8, 2012.
(60) Provisional application No. 61/678,460, filed on Aug. 1, 2012.

(51) Int. Cl. G06F 21/64

(52) U.S. Cl. CPC G06F 21/64
USPC 726/26

(57) ABSTRACT

A security method includes securely exchanging information related to delays of logic gates of a plurality of security primitives, and configuring a first and a second security primitive such that the delays associated with a subset of logic gates of the first and second security primitives match, for secure communication between the first and second security primitive. The security method may further include configuring the first security primitive and a third security primitive such that the delays associated with a subset of logic gates of the first and third security primitives match, for secure communication between the first and third security primitive. The security method may further include switching the configuration of the first security primitive in one clock cycle between the configuration for secure communication with the second security primitive and configuration for secure communication with the third security primitive.

### CROSS-REFERENCE TO RELATED APPLICATION

This application claims the benefit of U.S. Provisional Patent Application 61/680,976 filed Aug. 8, 2012 to Potkonjak et al., titled “Creating Secure Multiparty Communication Primitives Using Transistor Delay Quantization in Public Physically Unclonable Functions,” and U.S. Provisional Patent Application 61/678,460 filed Aug. 1, 2012 to Potkonjak et al., titled “Public Physically Unclonable Function Matching Using Device Aging,” both of which are incorporated by reference herein in their entirety.

### BACKGROUND

In many systems, security requirements include resiliency against physical and side channel attacks, low energy for communication, storage, and computation, and the ability to realize a variety of public key protocols. Hardware-based physically unclonable functions (PUFs) have emerged as hardware security primitives of choice for low-power embedded systems. A PUF is a multi-input system with one or more outputs that is difficult to reproduce due to physical and technological constraints, with functional dependencies between outputs and inputs that are difficult to predict.

In realistic communication systems, n-to-n public key communication is needed, where an unbounded number of arbitrary parties may communicate securely with each other.

### SUMMARY

In one aspect, a security method includes securely exchanging information related to delays of logic gates of a plurality of security primitives, and configuring a first and a second security primitive such that the delays associated with a subset of logic gates of the first and second security primitives match, for secure communication between the first and second security primitive. The security method may further include configuring the first security primitive and a third security primitive such that the delays associated with a subset of logic gates of the first and third security primitives match, for secure communication between the first and third security primitive. The security method may further include switching the configuration of the first security primitive in one clock cycle between the configuration for secure communication with the second security primitive and configuration for secure communication with the third security primitive.

In another aspect, a security system includes a first security primitive including a plurality of first cells, where each of the first cells includes at least one logic gate, and a second security primitive including a plurality of second cells corresponding to the plurality of first cells of the first security primitive, where each of the second cells includes at least one logic gate. The security system further includes a first processor function associated with the first security primitive, and a second processor function associated with the second security primitive. Each first cell logic gate corresponds to one second cell logic gate. For each first cell logic gate, the first processor function determines a parameter value and provides the parameter value to the second processor function, the second processor function compares the parameter value with a parameter value of the corresponding second cell logic gate; and the second processor function provides comparison information to the first processor.

In another aspect, a security apparatus includes a security primitive and a configuration mechanism. The security primitive includes a plurality of inputs, at least one output, and a plurality of paths extending between the plurality of inputs and the at least one output, where each path includes a plurality of cells. The configuration mechanism is configured to measure a parameter associated with a cell of the plurality of cells, and compare the parameter measurement to a value. If the parameter measurement is within a predefined amount of the value, the configuration mechanism adjusts the cell such that a later measurement of the parameter equals the value.

### BRIEF DESCRIPTION OF THE DRAWINGS

FIG. 1 illustrates an example of a system in which secure communication may be used.

FIG. 2 illustrates an example of a computing device.

FIGS. 3A-3C illustrate examples of quantization for a Gaussian distribution.

FIG. 4 illustrates probability of matching two cells for an example PUF design.

FIG. 5 illustrates an example of a PUF architecture.

FIG. 6 illustrates an example of an effect of cell replication on matching probability.

FIG. 7 illustrates an example of enabling/disabling inputs on booster, repressor, and terminator cells.

FIGS. 8A-8D illustrate examples of quanta placement.

FIGS. 9A-9C illustrate examples of effects of process variation.

FIG. 10 illustrates an example process for matching two PUFs.

FIG. 11A illustrates an example of pseudo-code for a public key exchange protocol.

FIG. 11B illustrates an example of pseudo-code for n-to-n public key communication.

FIG. 11C illustrates an example of computation effort for a simulation attack.

FIG. 12 illustrates an example of simulation results for prediction of output level.

FIG. 13A illustrates an example of an effect of cell replication on attacking probability.

FIG. 13B illustrates an example of an effect of quantization on attacking probability.

FIG. 14 illustrates an example of output stability versus delay variation.

FIG. 15 illustrates an example process for matching two PUFs.

FIG. 16 illustrates an example of a power-area-time product versus number of stages.

FIG. 17A illustrates an example of an entity authentication protocol.

FIG. 17B illustrates an example of a public key storage and communication protocol.

FIG. 18 illustrates an example of a PUF integrated into a computation block.

FIGS. 19A-19C illustrate examples of components in a computation block.

FIG. 19D illustrates an example of a booster cell.

FIG. 19E illustrates an example of a repressor cell.

FIGS. 20A-20B illustrate block diagrams of server side and client side configurations, respectively, in a distributed computing environment.

### DETAILED DESCRIPTION

This disclosure describes delay matching, where two PUF instances can be dynamically matched by disabling identified logic gates and leaving active a subset of logic gates with matched delays. The described PUF has a low probability of coincidence with a malicious PUF, thus n-to-n public key communication protocols are possible, enabling secure communication between an unbounded number of arbitrary PUF owners.

This disclosure describes a semiconductor integrated circuit (IC) architecture and two associated techniques for implementing hardware primitives useful in secure communications. The techniques of this disclosure may be adapted for multi-party public key communication protocols that can be performed using a single cycle of computation, with low power. The techniques of this disclosure may be implemented, for example, in wireless applications where conservation of energy is important.

In a first technique, referred to as parameter quantization, each PUF is characterized separately and the PUFs are then matched to each other. The term ‘characterized’ in this context indicates that a parameter value for each logic gate of a PUF is identified with an available quanta, or the logic gate is disabled. In a second technique, referred to as coordinated parameter matching, two PUFs are configured concurrently, taking into account the parameter values of each PUF.

The first technique of parameter quantization and the second technique of coordinated parameter matching are described below with respect to the parameter of propagation delay with a parameter value of time. Other parameters could alternatively be used, and include by way of example, output energy with a parameter value described in terms of Volts, Amps, Watts or Joules. Parameters vary for a variety of reasons, including variation due to manufacture or aging, and variation due to operational conditions such as temperature, supply voltage, adaptive body bias voltage, light exposure, and humidity.

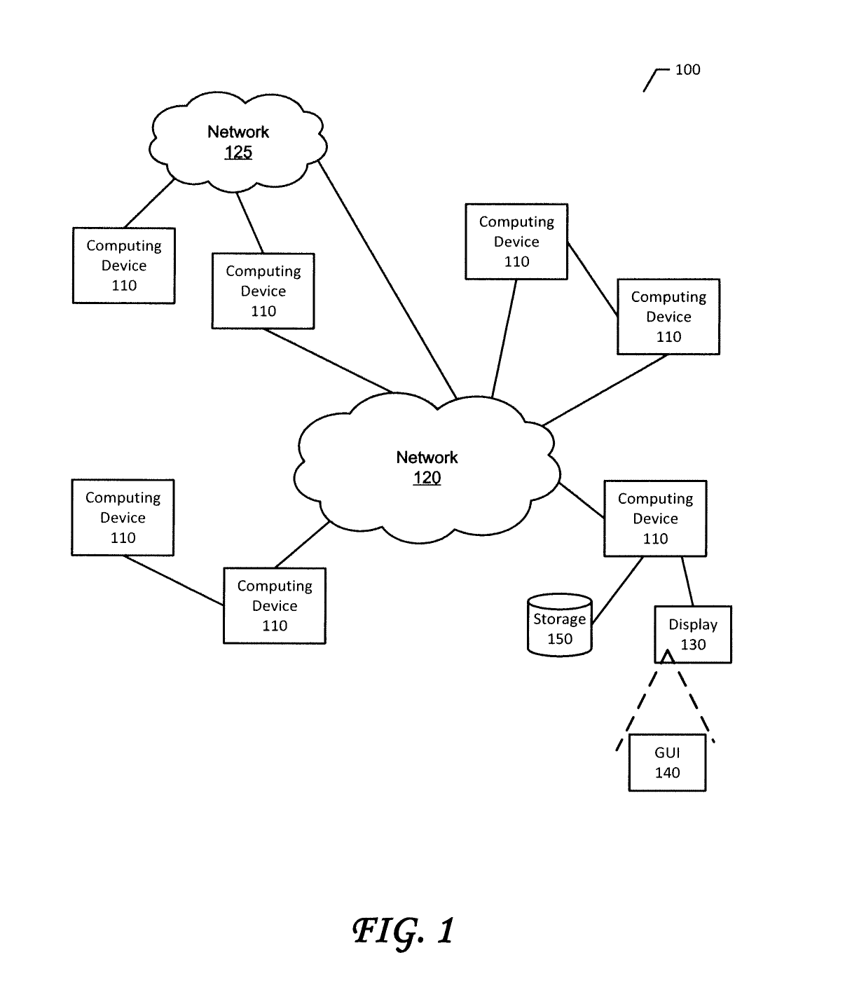

FIG. 1 illustrates an example of a system 100 in which PUF matching may be implemented and secure communication used. System 100 includes multiple computing devices 110, and networks 120 and 125. Components of system 100 can realize various different computing model infrastructures, such as web services, distributed computing and grid computing infrastructures.

Computing device 110 may be one of many types of apparatus, device, or machine for processing data, including by way of example a programmable processor, a computer, a server, a system on a chip, or multiple ones or combinations of the foregoing. Computing device 110 may include special purpose logic circuitry, such as an FPGA (field programmable gate array) or an ASIC (application specific integrated circuit). Computing device 110 may also include, in addition to hardware, code that creates an execution environment for a computer program, such as code that constitutes processor firmware, a protocol stack, a database management system, an operating system, a cross-platform runtime environment, a virtual machine, or a combination of one or more of the foregoing.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a network such as network 120 or 125.

Networks 120 and 125 represent any type of network, or a combination of networks. Networks 120 and 125 may include one or more of analog and digital networks, wide area and local area networks, wired and wireless networks, and broadband and narrowband networks. In some implementations, network 120 and/or network 125 may include a cable (e.g., coaxial metal cable), satellite, fiber optic, or other medium.

As illustrated in FIG. 1, computing device 110 may be in communication with another computing device 110 directly, or via one or more networks 120 and/or 125.

One computing device 110 of FIG. 1 is illustrated as being in communication with a display 130 having a graphical user interface (GUI) 140, and further illustrated as being in communication with a storage 150. Although one computing device 110 is illustrated as being in communication with display 130 (with GUI 140) and storage 150, other computing devices 110 may also be in communication with one or more displays 130 and one or more storages 150. Further, displays 130 and storages 150 may be shared by more than one computing device 110.

Display 130 is a viewing device such as monitor or screen attached to computing device 110 for providing a user interface to computing device 110. GUI 140 is a graphical form of user interface.

Storage 150 represents one or more memories external to computing device 110 for storing information, where information may be data or computer code.

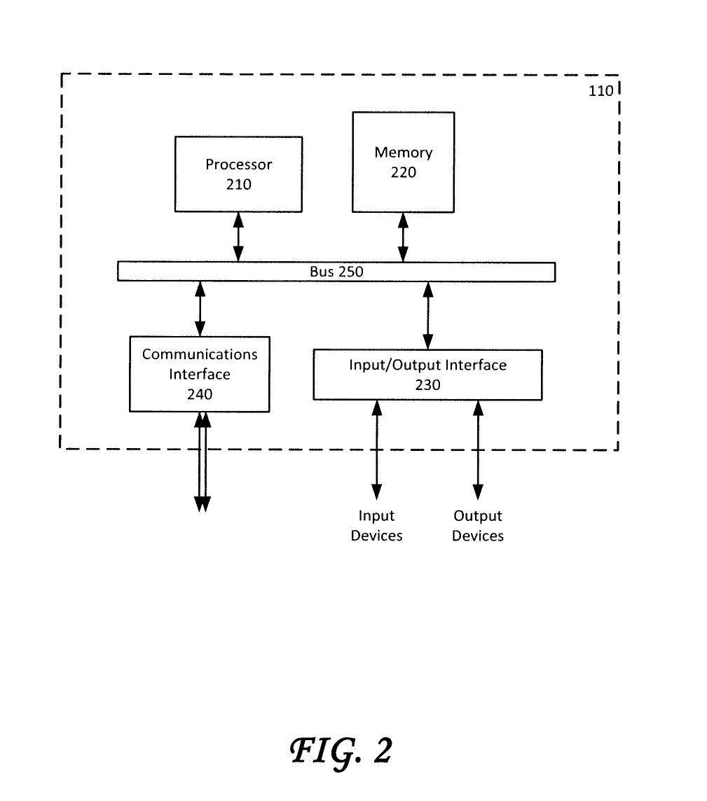

FIG. 2 illustrates an example of computing device 110 that includes a processor 210, a memory 220, an input/output interface 230, and a communication interface 240. A bus 250 provides a communication path between two or more of the components of computing device 110. The components shown are provided by way of illustration and are not limiting. Computing device 110 may have additional or fewer components, or multiple ones of the same component.

Processor 210 represents one or more of a microprocessor, microcontroller, ASIC, and/or FPGA, along with associated logic.

Memory 220 represents one or both of volatile and non-volatile memory for storing information. Examples of memory include semiconductor memory devices such as EPROM, EEPROM and flash memory devices, magnetic disks such as internal hard disks or removable disks, magneto optical disks, CD ROM and DVD-ROM disks, and the like.

Input/output interface 230 represents electrical components and optional code that together provides an interface from the internal components of computing device 110 to external components. Examples include a driver integrated circuit with associated programming.

Communications interface 240 represents electrical components and optional code that together provides an interface from the internal components of computing device 110 to external networks, such as network 120 or network 125.

Bus 250 represents one or more interfaces between components within computing device 110. For example, bus 250 may include a dedicated connection between processor 210 and memory 220 as well as a shared connection between processor 210 and multiple other components of computing device 110.

### Parameter Value Variation

Although semiconductor PUF architectures are typically composed entirely of digital logic, they are essentially analog systems in the sense that parameter values are continuous within specified upper and lower limits. Parameter values for each cell may differ even for cells implemented on one semiconductor device. A cell in this context refers to one or more transistor-level devices, together representing a particular function. Cells may include one or more logic gates. Examples of booster and repressor cells are described below.

Process variation (PV) affects parameter values, and is a generally unavoidable side product of silicon implementation technologies. On an IC, each component such as transistor, cell, or wire has unique physical (e.g. channel length) and manifestational (e.g. power and delay) properties, even when comparing identical designs of a component, or instances of the same design on a single IC. For example, for 180 nm technology, variations of up to 20× in leakage power and 30% in frequency on a single wafer due to PV have been shown. Causes of PV include line edge roughness, polysilicon granularity, and random discrete dopants. Each component also ages over time, potentially increasing the variation further. Device aging is a collective term for various types of phenomena which negatively impact circuit reliability and speed over the lifetime of a component. For example, device aging mechanisms in deep submicron silicon technologies include negative bias temperature instability (NBTI) and hot carrier injection (HCI).

### A Model for the Example of Delay

Equation (1) describes one example of a transistor-level PV delay model, with supply voltage ‘V_{dd}’ subthreshold slope ‘n’, mobility ‘μ’, oxide capacitance ‘Cₒₓ’, transistor gate width ‘W’, transistor gate length ‘L’, thermal voltage ‘kT/q’, drain induced barrier lowering (DIBL) factor ‘σ’, threshold voltage ‘Vₜₕ’, and delay and model fitting parameters ‘kₜₚ’ and ‘k_{fit}’. Load capacitance ‘C_{L}’ is defined in Equation (2), where ‘γ’ is the logical effort of the transistor gate and ‘W_{fanout}’ is the sum of the widths of load transistor gates.

$$\begin{matrix}Delay = \frac{{k}_{tp} \cdot {C}_{L} \cdot {V}_{dd}}{2 \cdot n \cdot μ \cdot {C}_{ox} \cdot \frac{W}{L} \cdot {( \frac{kT}{q} )}^{2}} \cdot \frac{{k}_{fit}}{{( ln ( {e}^{\frac{( 1 + σ ) {V}_{dd} - {V}_{th}}{2 \cdot n \cdot ( kT / q )}} + 1 ) )}^{2}} & ( 1 ) \\ {C}_{L} = {C}_{ox} \cdot L \cdot ( γ \cdot W + {W}_{fanout} ) & ( 2 )\end{matrix}$$

Parameters other than ‘W’, ‘L’, and ‘Vₜₕ’ are transistor-level properties represented as constant values in the model that can be derived using transistor-level simulation. There are two parameters in a model described by Equation (1) that are directly impacted by PV: effective channel length ‘L’ and threshold voltage ‘Vₜₕ’.

A Gaussian distribution based on the simulation of random dopant distribution is used in the model for ‘Vth’

A quad-tree model considers spatial correlations among transistors. In the quad-tree model, a transistor-level property (e.g. ‘L’) subject to PV is distributed into multiple levels, with a different number of grids allocated on each level. The grids on each level are assigned variation values that follow a normal distribution. The total value of a target transistor-level property is calculated as the sum of the variations on each level of the grids.

### Device Aging Model

NBTI occurs when a negative voltage is applied between the gate and source of a PMOS transistor, placing the transistor under stress and causing its gate voltage threshold to increase over time. The aging model shown in Equation (3) is used to model an effect of device aging on transistor gate threshold due to NBTI, where ‘A’ and ‘⊕’ are constants, ‘V_{G}’ is the applied transistor gate voltage, ‘E_{α}’ is the measured activation energy of the NBTI process, ‘T’ is the temperature, and ‘t’ is time.

ΔVₜₕ=A·e^{βV}^{_{G}}·e^{-E}^{_{α}}^{/kT}·t^{0.25} (3)

The model follows a fractional exponent; in other words, a relatively large amount of aging happens in a relatively short amount of time when the input vectors are first applied. After the stress is removed, there is some recovery, but it is not complete.

Aging can be forced relatively quickly by applying stress continuously. Some input vectors will age a particular cell more than others. For example, in a standard CMOS NAND cell with two PMOS transistors, an input vector ‘11’ will not place either PMOS transistor under stress, since the gates and sources of each transistor will have voltage ‘V_{dd}’, turning both PMOS transistors off. Input vector ‘00’, on the other hand, will place both transistors under stress, as the sources of both transistors will have voltage ‘V_{dd}’ and the gates of both transistors will have voltage 0 (zero), turning both PMOS transistors on. Input vectors ‘01’ and ‘10’ will each place one of the PMOS transistors under stress. For a CMOS NAND cell, each input-output path (single PMOS transistor) can be aged independently. In normal operation, cells are not generally maximally stressed, and may quickly and nearly full recover after each stress, allowing for switching between configurations to switch between communication with different PUFs. For aging in PUF matching, as discussed below, static aging may be used, which can be reversed by removing the applied stress.

### Example of Delay Quantization

An embodiment of the first technique of parameter quantization may be implemented using propagation delay as the parameter. Quantization of delays into a relatively few number of acceptable values allows two PUFs to match the same configuration without requiring quantization to be coordinated.

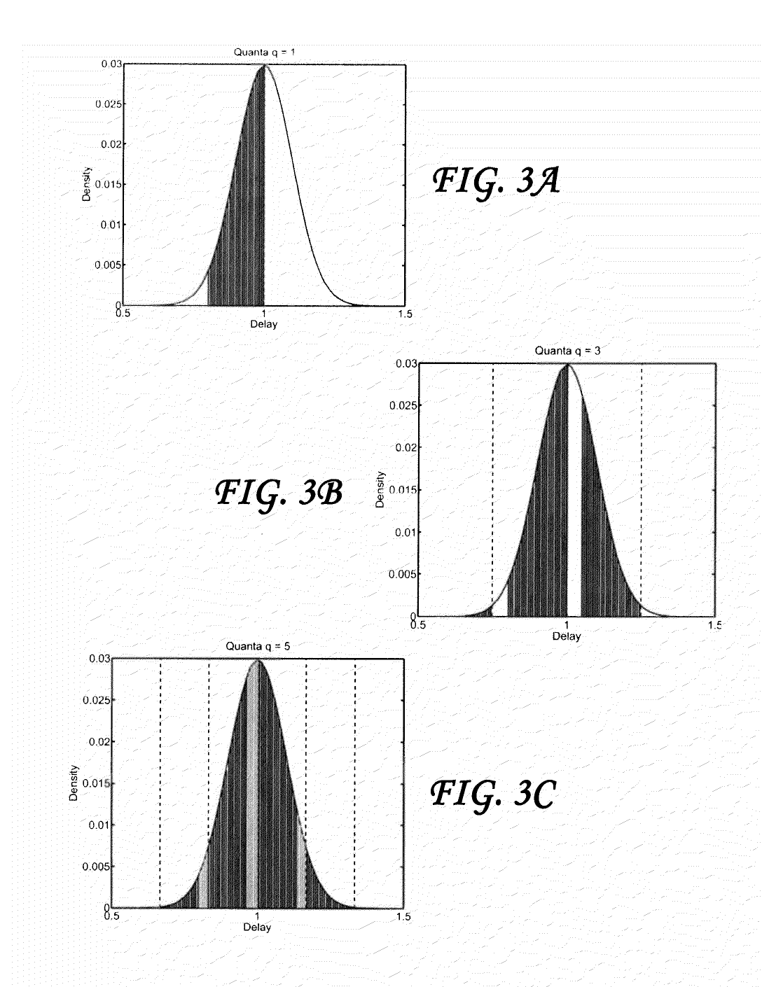

FIGS. 3A-3C illustrate, by way of example, quantization for a logic gate propagation delay with a Gaussian distribution, where μ=1 and σ=0.1, with minimum and maximum delay bounded at 0.5 and 1.5, respectively, and a maximum aging delay of 0.2. The curve represents the Gaussian distribution, and vertical dotted lines represent the defined quanta. For ease of illustration, the quantization strategy divides the region of possible delay values uniformly. Other quantization strategies may alternatively be used.

When identifying an available quanta for a logic gate, the potential increase in delay due to aging is taken into consideration, to a maximum value. Thus, in the single quantum example of FIG. 3A (defined quantum=delay of 1.0), logic gates with delay between 0.8 and 1.0 may age to a delay of 1.0 or greater, and are identified with quantum 1, whereas all other logic gates are disabled. In the three-quanta example of FIG. 3B (defined quanta 1, 2, 3=delay of 0.75, 1.0, and 1.25, respectively), logic gates with delay 0.55-0.75 may age to a delay of 0.75 or greater and are identified with quantum 1, logic gates with delay 0.8-1.0 may age to a delay of 1.0 or greater and are identified with quantum 2, logic gates with delay 1.05-1.25 may age to a delay of 1.25 or greater and are identified with quantum 3, and all other logic gates are disabled. In the example of FIG. 3B, logic gates with delay of <0.55, 0.75-0.8, 1.0-1.05, and >1.25 do not age to any quantum, and thus are disabled. As the number of quanta increases, a logic gate may age to a delay which may be identified with multiple quanta, and for these logic gates a quantum is chosen at random. FIG. 3C illustrates that such a case exists for maximum aging of 0.2 with five quanta, where logic gates with delays in the lighter-shaded areas may age to two different quanta.

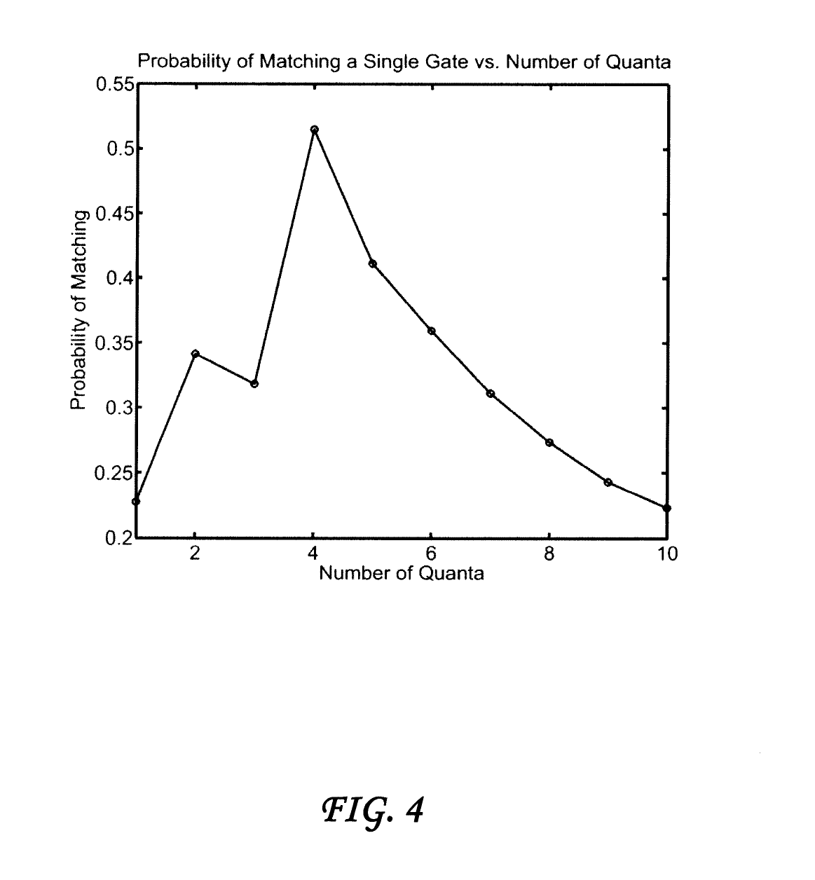

FIG. 4 illustrates a probability curve for matching two logic gates, one each on any two similar PUFs, as a function of the number of quanta, using an aging delay maximum of 0.2. The probability of matching is approximately 50% for the number of quanta ‘q’ equal to 4, and the probability of matching decreases for q>4 because delays begin to overlap at that point and quanta are chosen at random. For q=4, approximately half of the logic gates of two different PUFs will match (i.e., be identified with the same quantum) and may be used to form a secure communication channel using the two PUFs. The other approximately half of the logic gates may be disabled for communication using the two PUFs. After matching (in the example of q=4), the two PUFs are essentially identical and each PUF is approximately half its original size.

According to this first technique of Parameter quantization, two PUFs may be matched by enabling and disabling different subsets of logic gates. Enabling and disabling logic gates may be done in real time by applying the proper inputs to logic gates, and therefore secure communication with ‘n’ others may be performed by switching between ‘n’ previously-matched PUFs with little additional overhead in communication or computation latency.

Because there are a discrete and relatively small number of possible quanta for each logic gate, quantization improves stability of the PUF to variations in temperature or supply voltage, as there are larger gaps between acceptable delay values at each subsequent level of logic gates in a multi-level logic gate structure.

### Example of Semiconductor Architecture

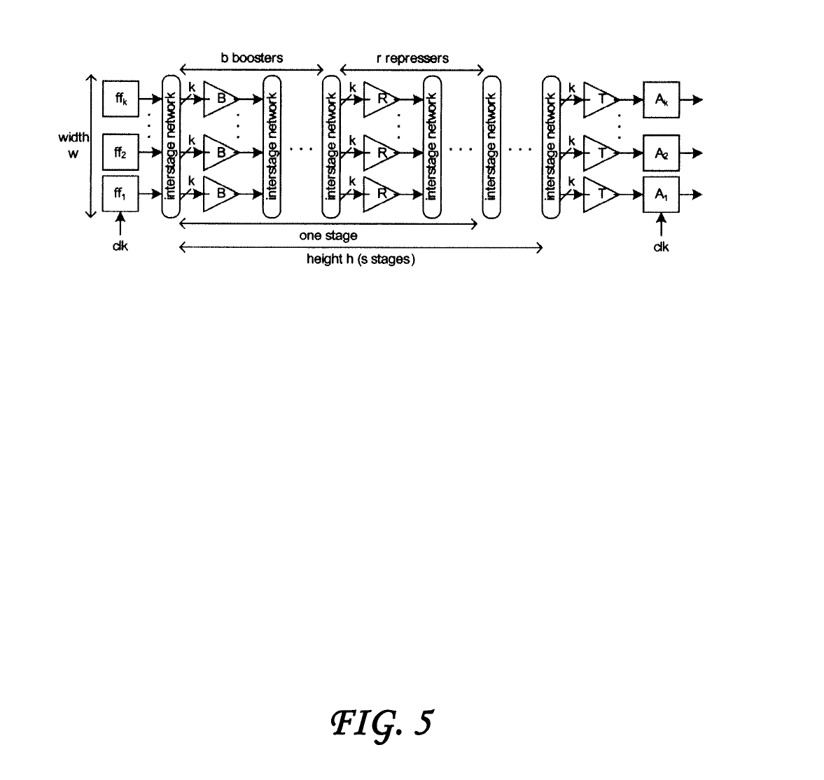

FIG. 5 illustrates an architecture for one example of a PUF. In the example PUF architecture of FIG. 5, the outputs of multiple flip-flops (ff₁-ffₖ) race through various paths through terminator cells (T) to arbiters (A₁-Aₖ). An arbiter has two inputs, one of which is connected to a clock signal and one of which is connected to receive a signal from a terminator cell. The arbiter outputs a logic ‘1’ if the input from the terminator cell transitions from logic ‘0’ to logic ‘1’ before the clock transitions from a logic ‘0’ to a logic ‘1’, and outputs a ‘0’ otherwise. The architecture has a width ‘w’ equal to the number of flip-flops. There may be multiple paths between each input and each output. The architecture has a number ‘s’ of stages, where each stage includes a number ‘b’ of k-input booster cells and a number ‘r’ of k-input repressor cells.

Booster cells serve to increase the switching frequency of a propagating signal. Repressor cells complement booster cells by unpredictably repressing frontier signal transitions that would otherwise lock the arbiters. The combination of booster and repressor cells creates great simulation complexity (i.e., in the context of an attack simulation.)

Booster cells increase the number of output transitions exponentially with the number of levels. Specifically, after ‘b’ levels of booster cells with boost factor ‘B’, the output switches by a factor, ‘b^{B}’, more than the input. One implementation of a k-input booster cell is a k-input XOR gate. For example, for a 2-input XOR gate, when either of the two inputs transitions from 0→1 or 1→0, the output will transition also. Therefore, a 2-input XOR gate has boosting factor B=2. It follows that a k-input XOR gate is a booster cell with boosting factor B=k.

A repressor cell should repress switching to enough of a degree that a high but unpredictable number of frontier signals are repressed. An example of a k-input repressor cell is a 4-input NAND gate. Out of a possible 64 input transitions, the output will switch for only 8: from ‘1111’ to any other input (4 transitions) or from any input to ‘1111’ (4 transitions). If the inputs to the NAND gate are random, then the gate represses with factor R=⅛.

Now consider the case where there are two consecutive levels of 4-input NAND gates, with random inputs to the first level. The first level represses with factor R=⅛, but the first level NAND gates output a logic ‘1’ approximately 94% of the time. As a result, the inputs to any of the NAND gates in the second level are likely to be in one of five transition cases (i.e., having four 1's or three 1's). Therefore, the second-level NAND gates effectively act as booster cells with boost factor roughly B=2. These results were verified by simulation.

In light of this observation, different repressor cells may be used at consecutive stages of the PUF. Specifically, four repressor cells with Karnaugh maps shown in Tables 1A-1D may be alternated at different stages. These repressors still drive the output to logic ‘1’, but output logic ‘0’ for different combinations of inputs in a balanced way around 1111. Simulation results show that the repressor cells maintain an average repression factor of approximately R=⅛ when alternating repressors are used in this way. Repressor cells may be implemented using inverters and a NAND gate to implement the Karnaugh maps of Tables 1A-1D.

TABLE 1B

| | 00 | 01 | 11 | 10 |
|---|---|---|---|---|
| 00 | 1 | 1 | 1 | 1 |
| 01 | 1 | 1 | 1 | 1 |
| 11 | 1 | 1 | 1 | 0 |
| 10 | 1 | 1 | 1 | 1 |

TABLE 1A

| | 00 | 01 | 11 | 10 |
|---|---|---|---|---|
| 00 | 1 | 1 | 1 | 1 |
| 01 | 1 | 1 | 0 | 1 |
| 11 | 1 | 1 | 1 | 1 |
| 10 | 1 | 1 | 1 | 1 |

TABLE 1C

| | 00 | 01 | 11 | 10 |
|---|---|---|---|---|
| 00 | 1 | 1 | 1 | 1 |
| 01 | 1 | 1 | 1 | 1 |
| 11 | 1 | 1 | 1 | 1 |
| 10 | 1 | 1 | 0 | 1 |

TABLE 1D

| | 00 | 01 | 11 | 10 |
|---|---|---|---|---|
| 00 | 1 | 1 | 1 | 1 |
| 01 | 1 | 1 | 1 | 1 |
| 11 | 1 | 0 | 1 | 1 |
| 10 | 1 | 1 | 1 | 1 |

The functionality of the PUF depends on the time of the first 0→1 signal transition at each output of the final level of cells. A terminator cell is used for each output to terminate all but the first 0→1 transition to increase the stability of the inputs to the arbiters. A terminator cell may be a k-input OR gate that shares the same signal for all of its inputs. An OR gate with high-enough number of inputs switches once for the first 0→1 transition. This is because an OR gate is logic ‘0’ if and only if all of its inputs are logic ‘0’, and the repressor cell outputs are logic ‘1’ a majority of the time. Further, any logic ‘0’ signals exist for so short a time, that it is very unlikely that for a high-enough number of inputs (in practice, k=4), a logic ‘0’ remains at an input long enough to drive the OR gate output to logic ‘0’.

The architecture of the example PUF of FIG. 5 has height h=s·(b+r). The cells in each sequential stage take as inputs the outputs of the cells in the previous stage. Terminator cells are added following the last stage to enhance stability. The booster, repressor, and terminator cells may be considered for the purposes of the following discussion to include k-input XOR, NAND, and OR gates, respectively, by way of example.

To achieve output unpredictability, difficulty of simulation (with respect to attacks), and matching ability, the interconnection network between consecutive levels should provide a high degree of signal mixing. In an ideal interconnection network, each input drives the same number of logic gates, two logic gates do not share many inputs, and after ‘h’ stages, each output depends on all inputs.

To match two PUFs, corresponding logic gates of the PUFs are matched, as described in further detail below. Alternatively or additionally, corresponding cells of the PUFs may be matched. Thus, in the following descriptions, where logic gates are described as being matched, cells may be matched, and where cells are described as being matched, logic gates may be matched.

### Replication

The probability of matching is one determinant of whether or not a cell remains active in a PUF. Another determinant is whether at least one of the cell's inputs also matches and is active.

Consider an example where the probability of matching a cell is 0.2, and each cell has 4 inputs. After matching, a first-level cell may be matched with probability 0.2. A second-level cell is active if and only if it matches and one of its inputs match, with corresponding probability of being active equal to 0.2·(1−0.8⁴)=0.12. The probability of being active decreases at every level, to below 1% at just the fourth level. Therefore, increasing the number of cells of a PUF is not a solution for increased matching by itself.

To increase matching, PUF cells are replicated and multiplexed such that matching is performed with respect to the combined delay of the replicated cells and the multiplexer. Consequently, for a number ‘p’ of replicas, a cell on one PUF has p² chances to match the corresponding cell on another PUF, instead of just one chance, resulting in a matching probability of P(p)=1−(1−P(1))^{p2}, where P(1) is the probability of matching with no replica.

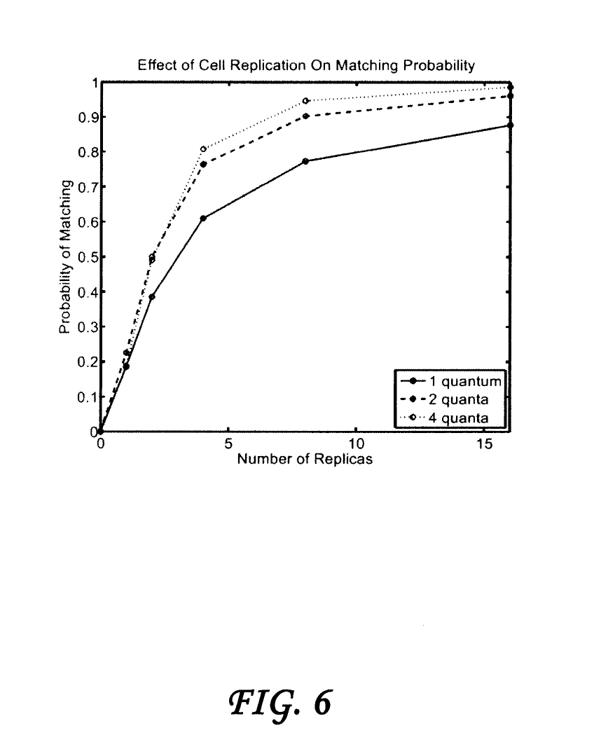

FIG. 6 illustrates the probability of matching a cell versus number of replicas for an architecture where P(1)≈0.2. The plotted probabilities do not follow the formula exactly because cell delays are correlated, especially the ‘p’ input-output delays of each cell's multiplexer, and therefore the formula represents an upper bound.

### Aging and Disabling Logic

To allow for fast and low-energy device aging, the PUF may include individual cell or logic gate input control.

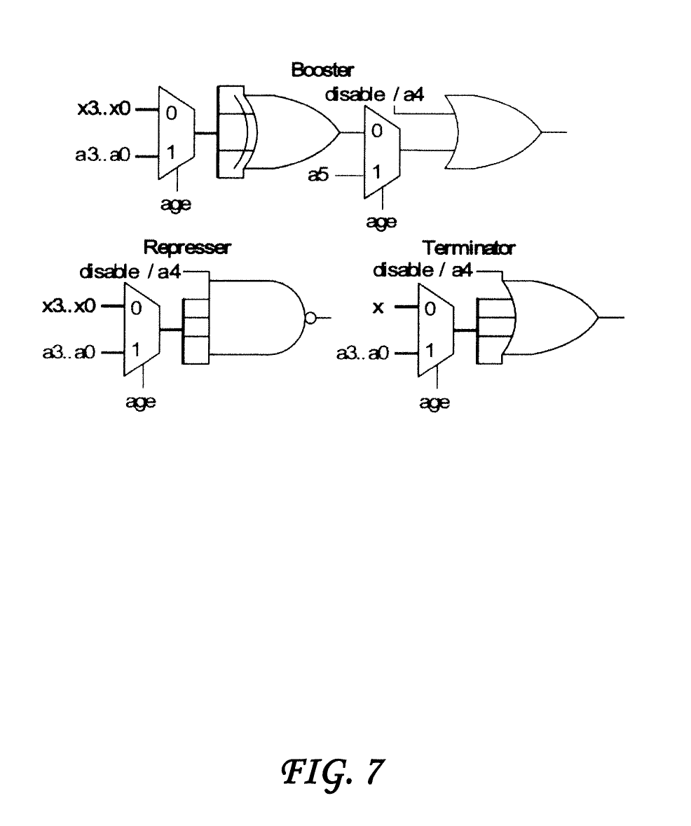

FIG. 7 illustrates examples of booster, repressor, and terminator cells with enabling/disabling inputs. For enabling/disabling a booster cell represented by an XOR gate, a 2-input OR gate may be added to the output of the XOR gate, and the booster cell disabled by applying a logic ‘1’ input to the OR gate. For enabling/disabling a repressor cell represented by a NAND gate, a primary input may be added to the NAND gate, and the repressor cell disabled by setting the added input to logic ‘0’. For enabling/disabling a terminator cell represented by an OR gate, a primary input may be added to the OR gate, and the terminator cell disabled by setting the added input to logic ‘1’. Disabling a cell prevents it from switching, akin to setting its delay to infinite delay.

The cells are further illustrated in FIG. 7 with an “age” input, which, when active, selects multiplexed inputs configured with aging data. Aging data may be applied to set specific input-output delays or to age the cell maximally.

The disable input may be used as another input for aging control.

### First Technique for Providing Secure Communication: Parameter Quantization

There are two conflicting goals in the selection of parameter quanta: it is desirable to have a high probability of matching two legitimate parties, while concurrently having a low probability of matching an attacker's PUF to the same configuration of a legitimately matched pair of PUFs.

High probability of matching: The security of a matched PUF pair is directly related to the size of the matched PUFs. As the probability of matching increases, the number of matched cells increases (i.e., the size of the PUF increases.) Therefore, a high probability of matching enhances security properties of the resulting PUF.

The probability that a cell on one PUF aged to a particular quantum matches the quantum for its corresponding cell on another PUF is dependent on the parameter distribution, the maximum parameter increase (e.g., from device aging), and the distribution of quanta. One goal of a quantization strategy for a cell, then, is to ensure that at least one quantum is reachable, such as by increasing propagation delay from device aging. However, even to achieve this single goal, quanta placement is a non-trivial optimization problem, since parameter distribution (and, e.g., aging) follow complex correlated models that may vary from cell to cell.

Furthermore, distributing quanta across the parameter distribution to maximize the area covered, for example, is likely not preferable, since parameter variation may not be uniformly distributed. Consider the case of propagation delay, where the delay follows a Gaussian distribution with μ=1 and σ=0.1, and maximum aging results in a delay increase of 0.2. Here, although placing quanta at 1 and 1.2 results in a greater probability for a cell to be able to reach a quantum (P(0.8<d<1.2=0.95) than placing quanta at 0.9 and 1.1 (P(0.7<d<1.1)=0.84), the probability of matching is greater in the latter case, where p²(0.7<d<0.9)+P²(0.9<d<1.1)=0.49, than in the former case, where P²(0.8<d<1.0)+P²(1.0<d<1.2)=0.46.

Low probability of matching: If a third PUF can match the same configuration as two matched PUFs, the security of the communication link between the two legitimately matched parties is compromised. A cell of the third PUF matches the paired configuration if: a) the corresponding matched cell is disabled; or b) the cell of the third PUF can be set using device aging to the same quantum to which the enabled cell is set. For example, for the case of one quantum and matching probability of 0.2, the probability of successful attack on a cell is the sum of the probabilities of the two mutually exclusive cases a) and b) described above, or 0.8+0.2²=0.84. As the number of quanta increases, the probability generally decreases. However, if there are overlapping quanta, and cells on legitimate PUFs are assigned to available quanta at random, the probability of matching the third PUF increases, because the third PUF is aged a posteriori.

A high probability of legitimately matching two PUFs would result in a correspondingly high probability of matching an attacking PUF to a target PUF or target matched PUF pair. However, a defense against this type of attack can in principle be satisfied to any arbitrary degree of certainty by increasing the size of the PUF, as the attacker would need to match the exact configuration across every cell of the entire PUF.

### Quantization Strategies

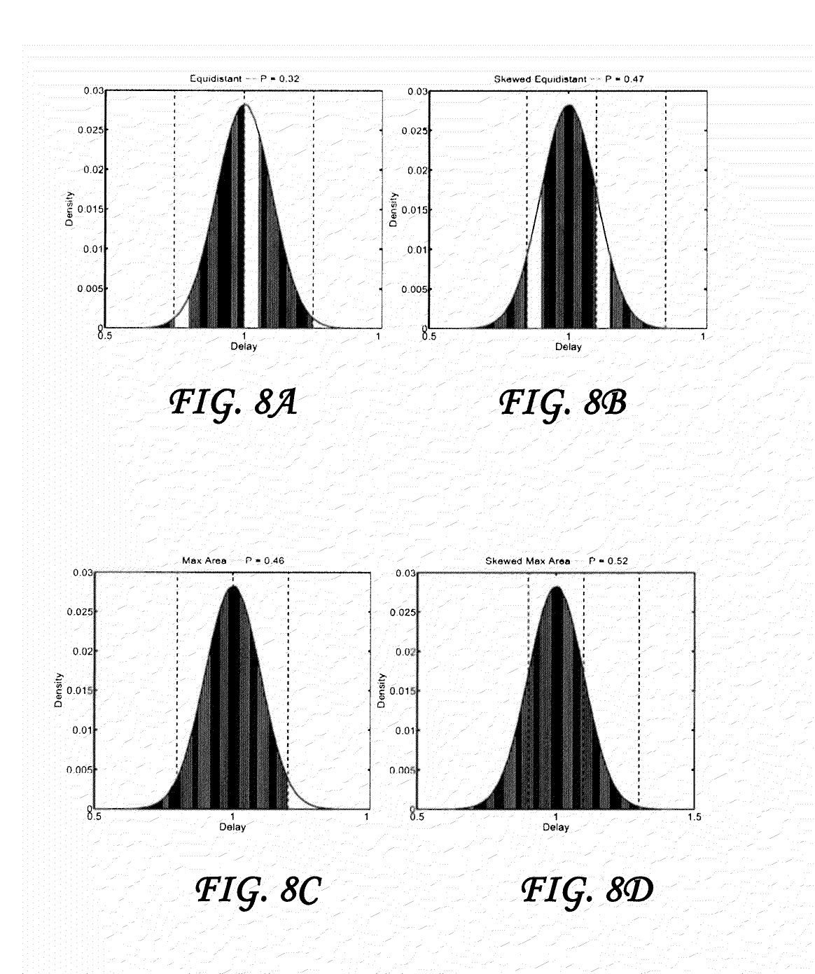

FIGS. 8A-8D illustrate four example strategies for propagation delay quanta placement for a Gaussian delay model with ‘μ’=1, ‘σ’=0.1, maximum delay aging of 0.2, and three quanta.

FIG. 8A illustrates equidistant matching. Quanta are placed such that they span uniformly across the distribution of delays. This strategy may be useful if expected delay distributions and maximal aging amounts are unknown ahead of time. Matching probability for this strategy is 0.32.

FIG. 8B illustrates skewed equidistant matching. Quanta are placed such that they span uniformly across the distribution of delays, but are offset by half the maximum amount of delay aging. Skewing the quanta by this amount balances (and therefore increases) the portion of the delay distribution that can be aged to match a quantum. This strategy may be useful when maximal aging of a cell can be predicted easily. Matching probability for this strategy is 0.47.

FIG. 8C illustrates maximum area matching. Quanta are placed such that the maximum area of cell delays lie between each quanta. For delay distributions that are non-uniform, the strategy illustrated in FIG. 8C is not preferred, since the goal is to maximize the number of cells that can match quanta. The maximum area strategy may be useful if the delay distribution is known a priori. Matching probability for this strategy is 0.46.

FIG. 8D illustrates skewed maximum area matching. Quanta are placed such that they span uniformly across the distribution of delays, but are offset by half the maximum amount of delay aging. This strategy may be useful if both the delay distribution and the maximal delay aging of the cell are known or can be predicted relatively accurately a priori. Matching probability for this strategy is 0.52.

For some protocols, it is important that each cell can be set to an available quantum. For this case, the number of quanta used may be high, and a quantum is chosen at random for a particular cell. Although this approach may decrease the probability of matching and increase the probability of attacking, an increased number of quanta results in increased size (and therefore security) of the matched PUF. This strategy may be useful if the delay distribution cannot be predicted accurately.

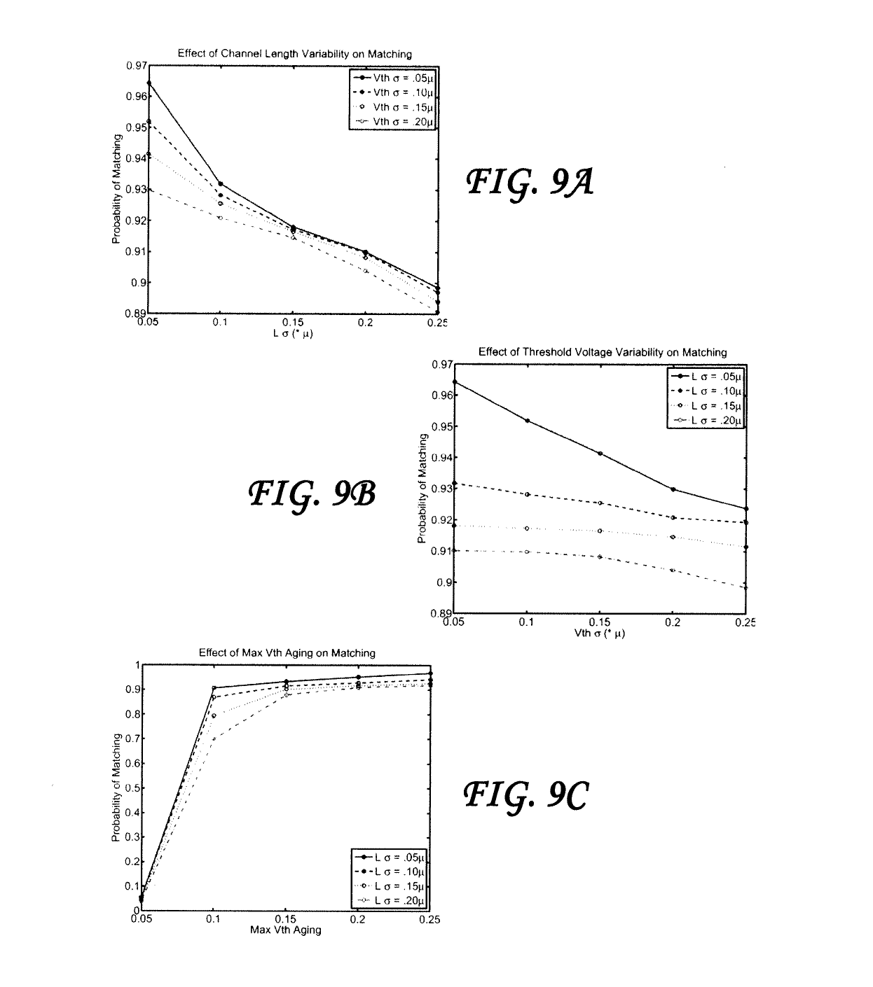

If all cells have identical quanta, security of the PUF is compromised as there are few possible values for the initial arrival time of PUF output signals. Therefore, a small random component may be added to selected quanta at selected cells. For example, FIGS. 9A-9C illustrate an example of the effects of the degree of variation in ‘L_{eff}’ (effective channel length), ‘Vₜₕ’ (threshold voltage), and maximum degree of ‘Vₜₕ’ aging, respectively, on the probability of matching. Simulations were performed with 8 replicas and 8 quanta placed using a skewed equidistant matching strategy with random assignment of overlapping quanta. Simulation results showed that increasing ‘L_{eff}’ variability decreases matching probability by decreasing the impact of ‘Vₜₕ’ aging. The same effect was shown for increasing ‘Vₜₕ’ variability. Furthermore, increasing the maximum degree of ‘Vₜₕ’ aging increases probability of matching, though the effect diminishes as the degree of aging approaches or surpasses the degree of variability.

n-Party Public Key Exchange

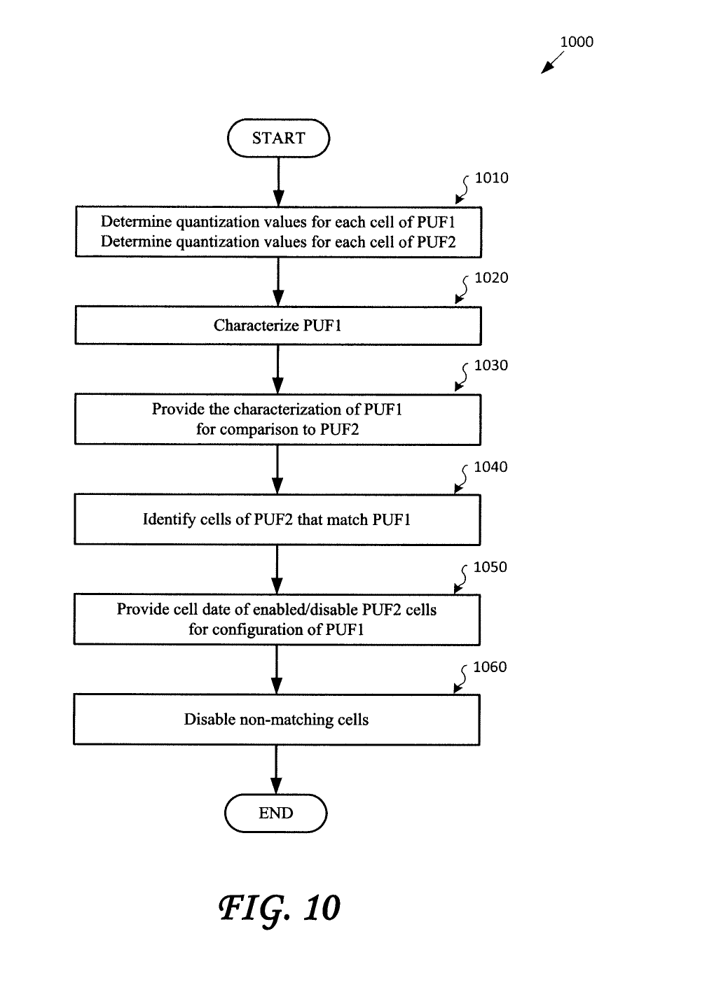

FIG. 10 illustrates an example process 1000 for matching two PUFs according to the first technique of delay quantization. Process 1000 starts at block 1010, where quantization values for each cell of two PUFs, PUF1 and PUF2, are determined independently. As described above, a quantization value may not be available for a cell. At block 1020, PUF1 is characterized, where characterization includes identifying a quantum setting (or disabled state) for each cell of the PUF. At block 1030, the characterization of PUF1 is provided for a comparison to PUF2. The provision of the characterization may be made through a trusted third party. The trusted third party may also perform the comparison to PUF2. At block 1040, cells are identified for which the assigned quanta of respective cells of PUF1 and PUF2 match. At block X40, cell data representing PUF2 is provided. For example, cell data may be a string of binary numbers representing the cells of PUF2, where a logic ‘1’ indicates a match between the corresponding cells of PUF1 and PUF2, and a logic ‘0’ indicates not matching. At block 1060, cells of PUF1 and PUF2 that do not match are disabled, such that PUF1 and PUF2 are identically configured for secure communication. Cells may be disabled separately, or all together in a single clock cycle.

In the example of FIG. 10, the characterization of a PUF will correspond to n·log(q) bits of communication, where ‘n’ is the number of cells and ‘q’ is the number of available quanta. The cell data for a PUF will correspond to ‘n’ bits of communication. Thus, the matching of a pair of PUFs expends n·(log(q)+1) bits of communication energy. Compression may be used to minimize the number of bits of communication. Communication between any two PUFs requires performing matching once.

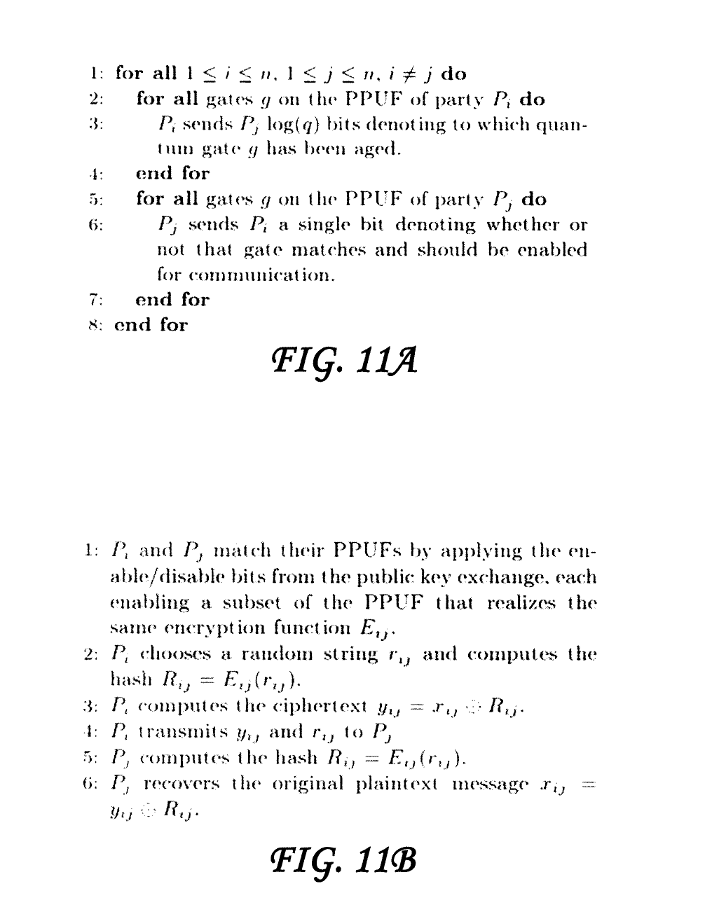

FIG. 11A illustrates an example of pseudo-code for a public key exchange protocol between n arbitrary parties P₁ . . . Pₙ, each with a quantized PUF. No confidential information is leaked, since the configurations of the involved PUFs are public information.

n-to-n Public Key Communication

FIG. 11B illustrates an example of pseudo-code for an n-to-n public key communication protocol, defined herein as communication between an unbounded number of arbitrary parties. The example of FIG. 11B describes a public key communication protocol as an extension of the public key exchange protocol described with respect to FIG. 11A. A party ‘Pᵢ’ wants to securely send a secret plaintext message ‘xᵢⱼ’ to an arbitrary party ‘Pⱼ’. The message is encrypted with an encryption function ‘Eᵢⱼ’, which is the encryption performed by either of the matched PUFs. The communication is secure because the only information transmitted in the exchange is the random string ‘rᵢⱼ’, which is independent of the plaintext message ‘xᵢⱼ’ and the ciphertext ‘yᵢⱼ’. The message ‘xᵢⱼ’ cannot be recovered from ‘yᵢⱼ’ unless (rᵢⱼ)·(Eᵢⱼ) is computed, which cannot be done (or predicted using knowledge of ‘rᵢⱼ’) by anyone other than the owners of the matched PUFs, in this case only ‘Pᵢ’ and ‘Pⱼ’.

Because the disabling of different subsets of cells may be done in the same clock cycle as PUF computation, a party may communicate securely with any other party using the corresponding public key with little communication overhead.

In the following paragraphs, results of some simulations are presented. The simulations used PUFs of width 128, including 7 stages of 2 boosters and 1 repressor each, with 8 replicas and two quanta for each cell (unless otherwise specified). Simulation used 10,000 input vectors.

Potential security attacks against an individual PUF include guessing, simulation, and technological attacks. In guessing attacks, an attacker observes a polynomial number of challenge-response pairs and tries to statistically analyze them in order to predict the answer to an unseen challenge. In simulation attacks, the computation effort is too great to be practical. FIG. 11C shows computation effort for a 1 GHz processor simulating a PUF of width w=128 and various (very short) heights. The growth is exponential, rendering simulation attacks intractable for even modest PUF sizes.

Technological attacks may be, for example, prediction, side channel, cloning, and emulation attacks.

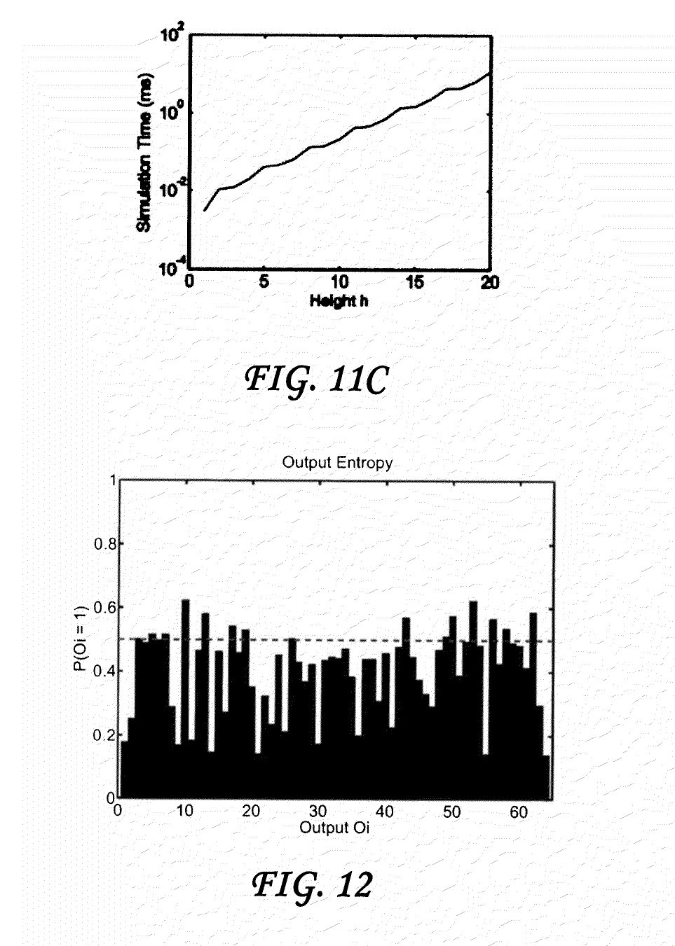

In a prediction attack, the attacker tries to predict each output ‘Oᵢ’ using knowledge of previously observed input-output pairs, with a goal of predicting P(Oᵢ=c), where c=0 or 1. FIG. 12 shows simulation results for the probability that output cells will be logic ‘1’ for one representative PUF subset of cells. Ideally, an output is logic ‘0’ or ‘1’ with equal likelihood (probability 0.5, shown as a dashed line.) However, protocols can choose to use only those outputs which are most unpredictable. Even for a small circuit there are many such outputs.

Side-channel attacks are not a threat, because the power profile of a cell would not reveal any new information, as cell delays are available as a public key.

In an ‘ideal’ cloning attack, an attacker would need to fabricate an identical PUF to a target PUF. Parameter variation makes such a clone not possible.

An emulation attack is a more general version of a cloning attack. In an emulation attack, the attacker attempts to create an IC with larger timing delay, but with the same relative timing characteristics. However, because cell delays are quantized in the first technique described above, multi-level input staggering provides resiliency to emulation attack. For example, primary input signals may be applied to any cell using the aging inputs, thereby rendering relative cell delays of an attacker ineffective, because the attack must match all delays exactly.

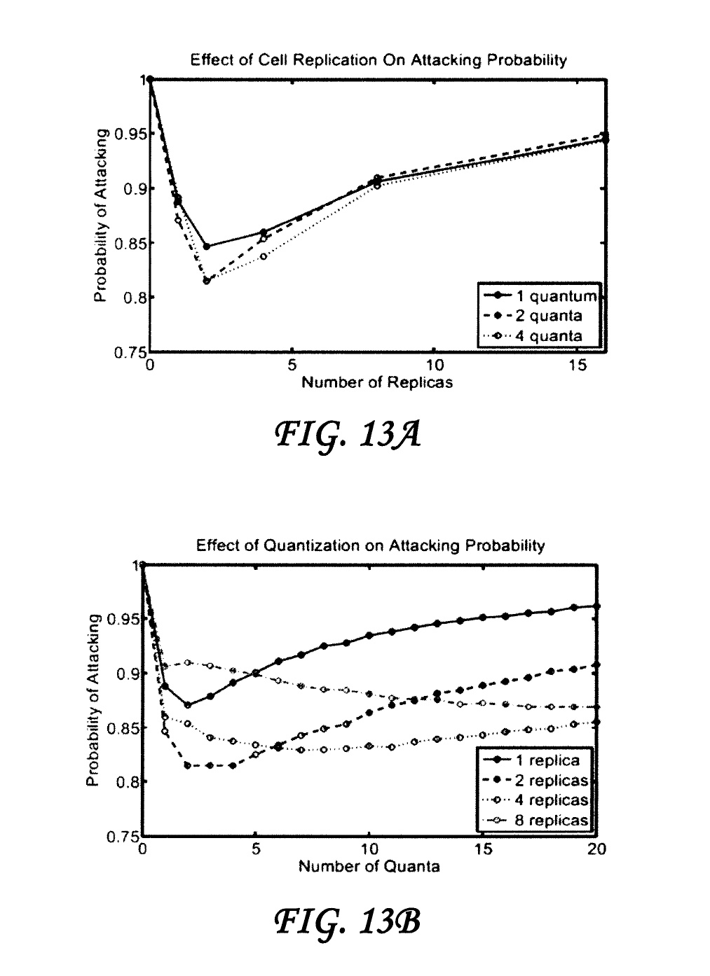

Attacks against matched PUFs are essentially protocol attacks that attempt to exploit vulnerabilities in policies for the exchange of data. The attacker must configure a third PUF using aging to match the two legitimately matched PUFs. In order to a posteriori match the same configuration, the attacker must be able to match every legitimately matched cell in terms of delay. FIGS. 13A and 13B are simulation results regarding the probability of success for such an attack for a single cell. FIG. 13A is the probability versus number of replicas, and FIG. 13B is the probability versus number of quanta. An attacker must match every cell of the PUF to the legitimately matched PUFs in order to launch a successful attack. For even modest PUF sizes the probability of success is effectively zero. For instance, for a relatively high probability of 0.9 of successfully attacking a single cell (high replication and quantization), the probably of matching the entire PUF is on the order of 10⁻⁹² for a PUF of just 2000 cells.

### Stability Against Voltage and Temperature Variation

Because of the difficulty of predicting or simulating PUF outputs, it is not necessary to verify that a PUF can produce all output bits without error. For example, consider the case where all delay quanta across all cells of a PUF are set with granularity 0.5 such that signal transitions should occur at time multiples of 0.5. For this case, a signal that is measured to arrive at time 4.397 can be assumed to actually arrive at time 4.5, the closest acceptable quanta specified by the granularity of the quantization strategy. If an output bit is mismatched, the authenticating party may request the exact measured arrival time of the output bit and accepts the bit if the actual arrival time is close enough to the expected arrival time.

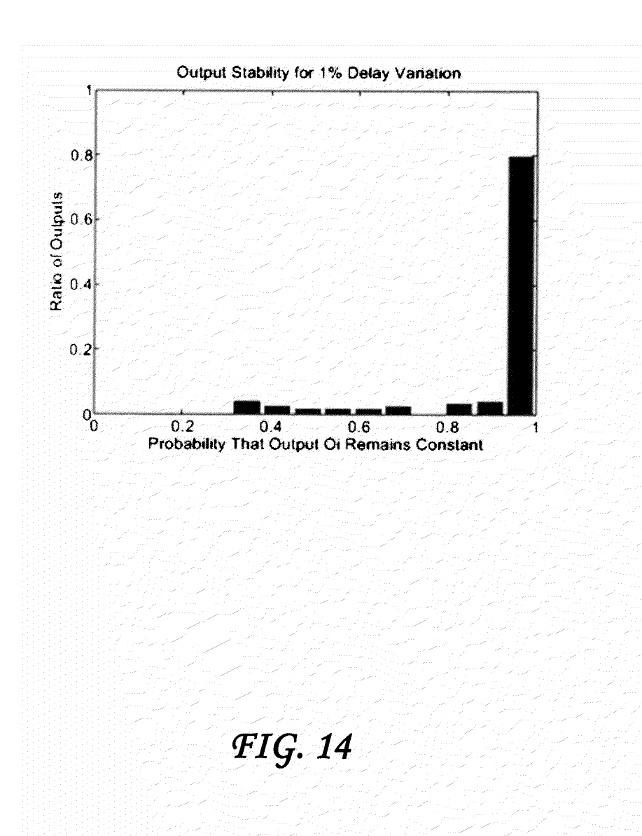

Delay variation may be modeled as uniform random noise, and a simulation using such a model provides the results illustrated in FIG. 14 for 1% delay variation, showing that a majority of the outputs remain constant in the presence of delay variations.

Thus has been described a first technique for providing secure communications using delay quantization.

### Second Technique for Providing Secure Communication: Coordinated Parameter Matching

In a second technique for providing secure communications, PUFs are matched to each other without prior characterization.

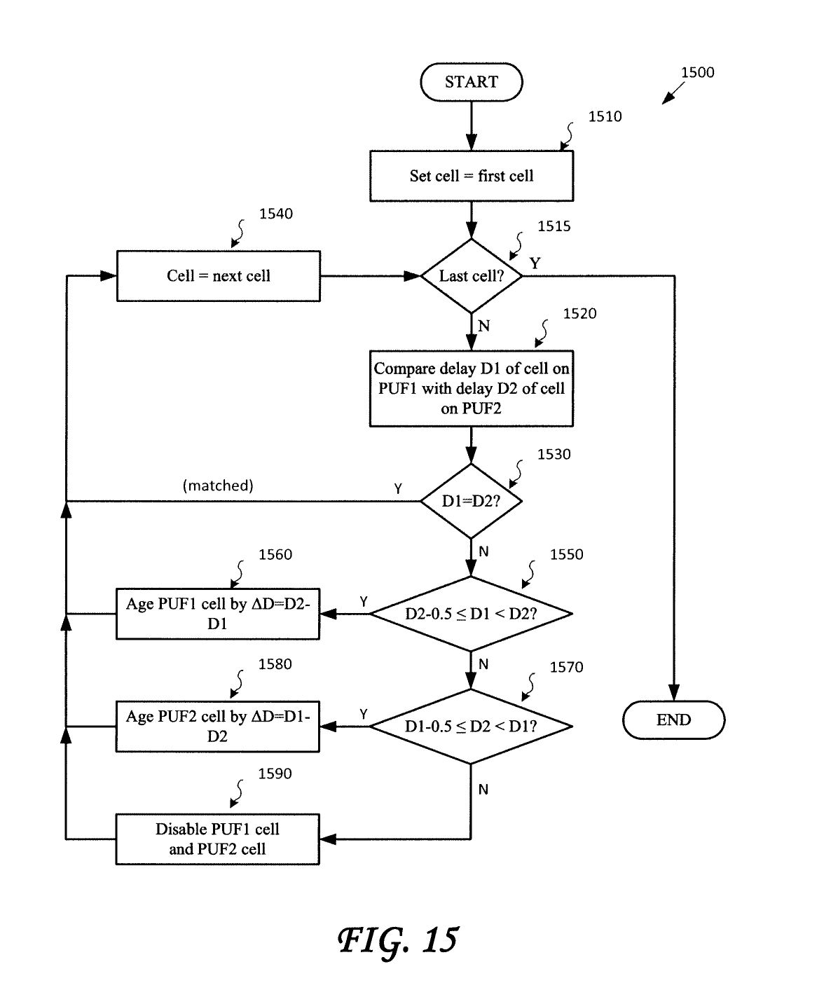

FIG. 15 illustrates a process 1500 for matching two PUFs according to the second technique. For the process 1500, assume a Gaussian distribution for cell delay between 0 and 1, and maximal aging of a cell increases its delay by 0.5. Process 1500 starts at block 1510 by selecting a first cell of a first PUF (PUF1) and the corresponding first cell of a second PUF (PUF2), and determining at block 1515 if it is the last cell to be compared. If yes, process 1500 ends. Otherwise, process 1500 continues at block 1520 to compare the delay of the selected cell on PUF1 to the delay of the selected cell on PUF2.

At block 1530, if the delays were equal in the comparison at block 1520, the cells already match, and process 1500 continues at block 1540 to select the next cell. If at block 1530 it was determined that the delays were not equal, process 1500 continues at block 1550 to determine if delay D1 of the selected cell of PUF1 is between the delay D2 of the selected cell of PUF2 and the delay D2 minus 0.5. If yes, the selected cell of PUF1 is aged at block 1560 by an amount ΔD=D2−D1, and process 1500 continues at block 1540 to select the next cell. Otherwise, process 1500 continues at block 1570 to determine if delay D2 of the selected cell of PUF2 is between the delay D1 of the selected cell of PUF1 and the delay D1 minus 0.5. If yes, the selected cell of PUF2 is aged at block 1580 by an amount ΔD=D1−D2, and process 1500 continues at block 1540 to select the next cell. Otherwise, process 1500 continues at block 1590 to disable the selected cell in both PUF1 and PUF2, and process 1500 continues at block 1540 to select the next cell.

Cases for which a selected cell cannot be matched include when D1<D2−0.5 or D2<D1−0.5. The probability of either of these events occurring is 0.25. Therefore, an average of 75% of the cells may be matched.

An attack may attempt to match a third PUF (PUF3) to the configuration determined for PUF1 and PUF2 through the second technique of coordinated cell delay matching. For a cell that was disabled in the matched PUF1/PUF2 pair, the corresponding cell of PUF3 is disabled. For a cell that was matched in the PUF1/PUF2 pair, the corresponding cell of PUF3 may be matched if it is faster than the slowest cell of either of PUF1/PUF2 but not more than 0.5. This constraint may be described by the equation: max(D1, D2)−0.5<D3<max(D1, D2), where D3 is the delay of the cell in PUF3. The probability that a cell of PUF3 will match the corresponding cells of the matched PUF1/PUF2 pair is 7/12. Therefore, approximately 58% of the cells of PUF3 will match the PUF1/PUF2 pair.

After matching, PUF1 and PUF2 (and, statistically speaking, no other PUF) will (ideally) produce exactly the same unique response to any challenge in a single cycle. Therefore, for example, a system including PUF1 may issue a challenge and a system including PUF2 may verify the response, enabling a myriad of low-energy cryptographic protocols.

Thus is described by the second technique of coordinated parameter matching a matched PUF pair which is an ultra low power cryptographic primitive with implementation that requires only a single cycle for security protocols.

An energy optimization technique may be implemented for either the first or the second technique, to reduce energy spent in transmission while maintaining security. The energy optimization technique includes three phases. A small set of input vectors is applied after matching, and a fast, low-cost statistical analysis performed to identify outputs with close to 50% probability of being either logic ‘0’ or logic ‘1’, and those that are not easily predicted by others.

In the first phase, outputs that are often logic ‘0’ (or alternatively logic ‘1’) are combined into a single output which is logic ‘0’ (or logic ‘1’) if all combined outputs are logic ‘0’ (or logic ‘1’). This can be done with minimal hardware overhead using an additional level of OR and AND gates. In the second phase, those outputs that are logic ‘0’ (or logic ‘1’) with probability P>|0.5−δ| for specified δ are eliminated. In the third phase, outputs that can be predicted by other outputs with certainty greater than a specified threshold are eliminated. Thus, a maximal independent set of outputs that are not often logic ‘0’ (or logic ‘1’) are transmitted.

Another energy optimization technique includes arbitration between output signals and clocks, where all outputs are arbitrated against a single clock signal. The response to a challenge is computed in a single clock cycle. The chosen clock period is the one that maximizes output entropy, which can again be determined using statistical analysis.

A different arbitration technique may be used for increasing security. A challenge is executed multiple times with different clocks, and each output is selected such that its entropy is increased.

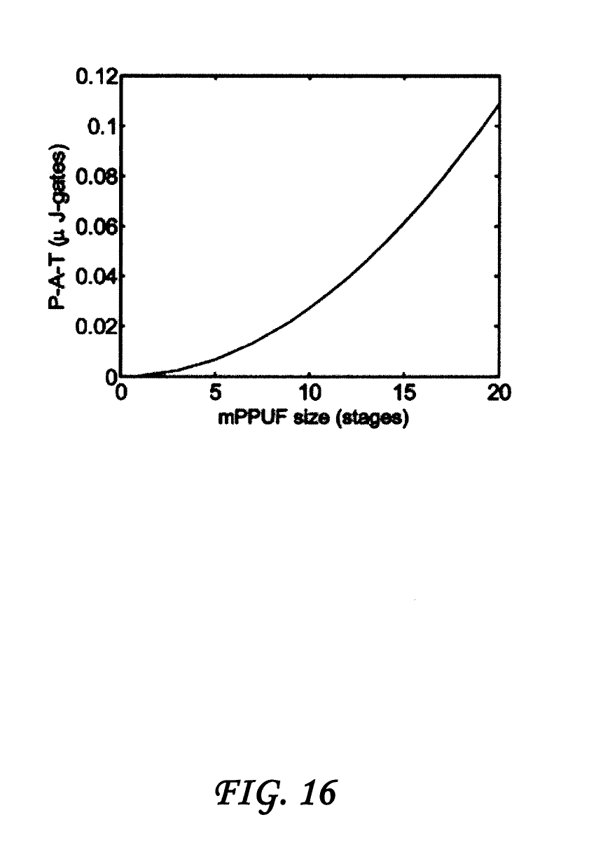

For purposes of comparison, FIG. 16 illustrates a graph of power-area-time (P-A-T) product versus number of stages for a system such as the one illustrated in FIG. 5, implemented in 0.13 μm technology, where w=128, b=2, r=1, and V_{dd}=0.75V. For a matched PUF with s=20 (36,000 equivalent cells), P-A-T is very low (0.11 μJ-cells). This is largely due to the fact that the entire computation is done in a single clock cycle, with critical path delay of 2.6 ns, total power consumption of 1.2 mW, and total energy of 3.1 pJ.

### Examples of Protocols

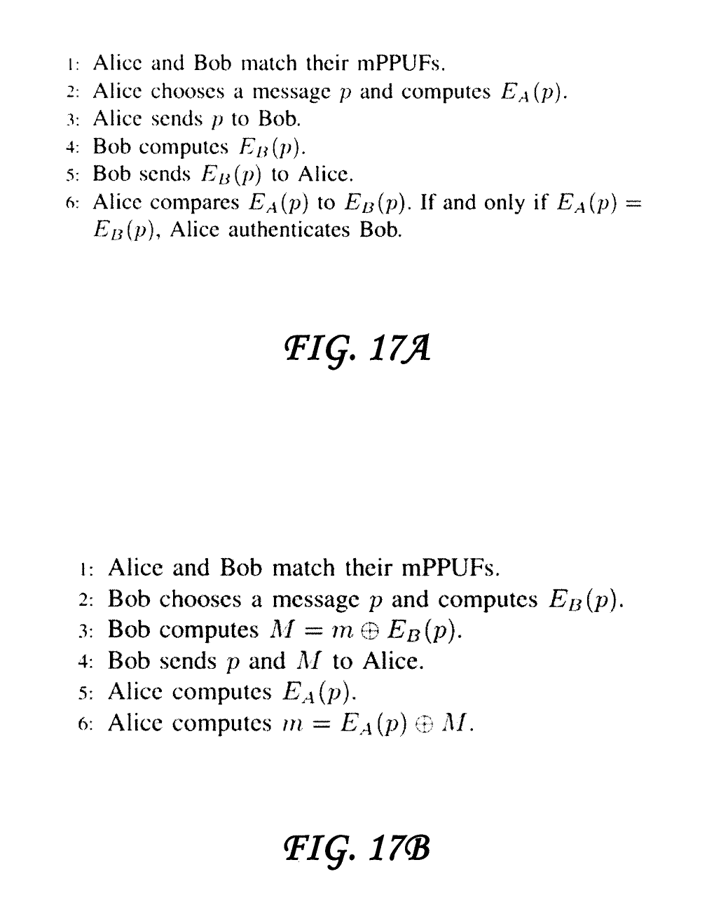

FIGS. 17A and 17B provide examples of protocols that may be used after two PUFs are matched using either the first technique of Parameter quantization or second technique of coordinated parameter matching. FIG. 17A is an example of entity authentication, and FIG. 17B is an example of public key storage and communication. The protocol examples are presented in terms of two PUF holders Alice and Bob for simplicity. E_{A}(m) and E_{B}(m) are encryption functions provided by Alice's and Bob's PUFs, respectively, on a message ‘m’. After Alice and Bob match their PUFs, E_{A}(m)=E_{B}(m).

Entity authentication, such as the example in FIG. 17A, is a basic cryptographic protocol relying on the properties that only a PUF matched with Alice's PUF can produce the same response to the same challenge, and that only Bob's PUF matches Alice's PUF.

Public key storage and communication, such as the example in FIG. 17B, is a basic part of public key cryptography. In public key communication, Bob sends Alice a message ‘m’ such that Alice can read it but no other party can learn any new information about ‘m’ other than its encrypted value. Because E_{A}(p)=E_{B}(p) if and only if Alice and Bob have matched their PUFs, only Alice is able to extract the full original message ‘m’.

Alternatively, for public key storage, Alice does not match her PUF with any other PUF (i.e. all cells remain enabled), computes M=m⊕E_{A}(p), and stores ‘M’ and ‘p’. To decrypt the message, Alice computes m=E_{A}(p)⊕M.

An advantage of matched PUFs using the techniques described in this disclosure is, as discussed, that execution of public key protocols in a single clock cycle is possible with resiliency against physical and side channel attacks. Another advantage is that integration with standard logic is possible for secure flow of information, allowing for new security, privacy, and trust protocols.

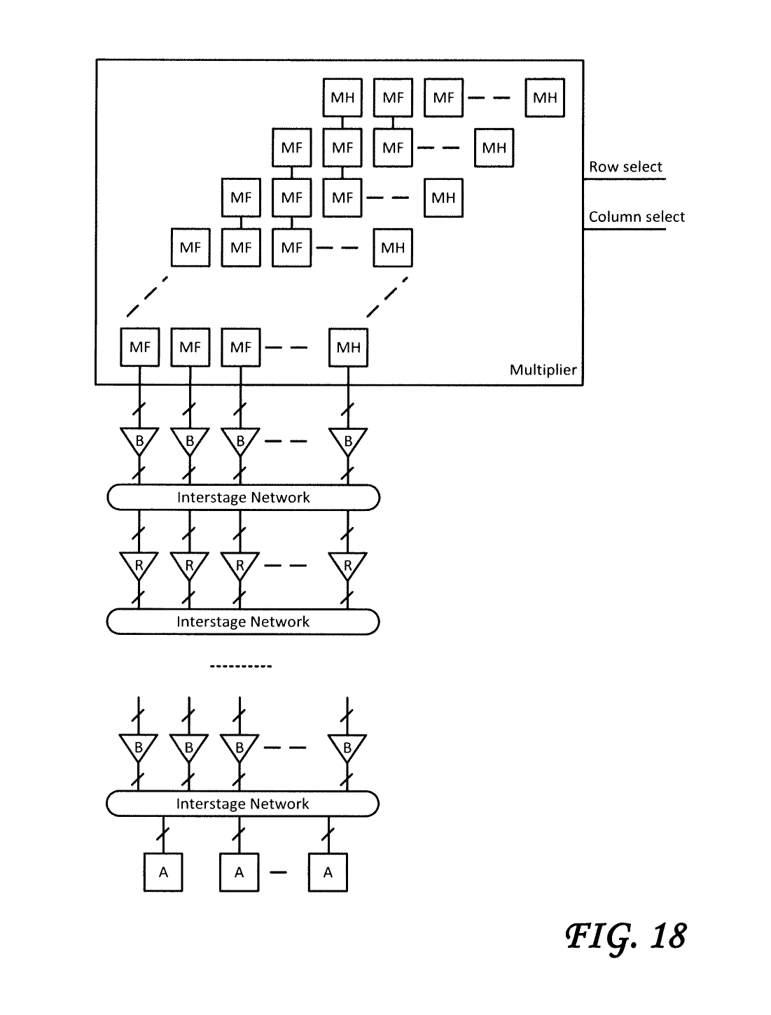

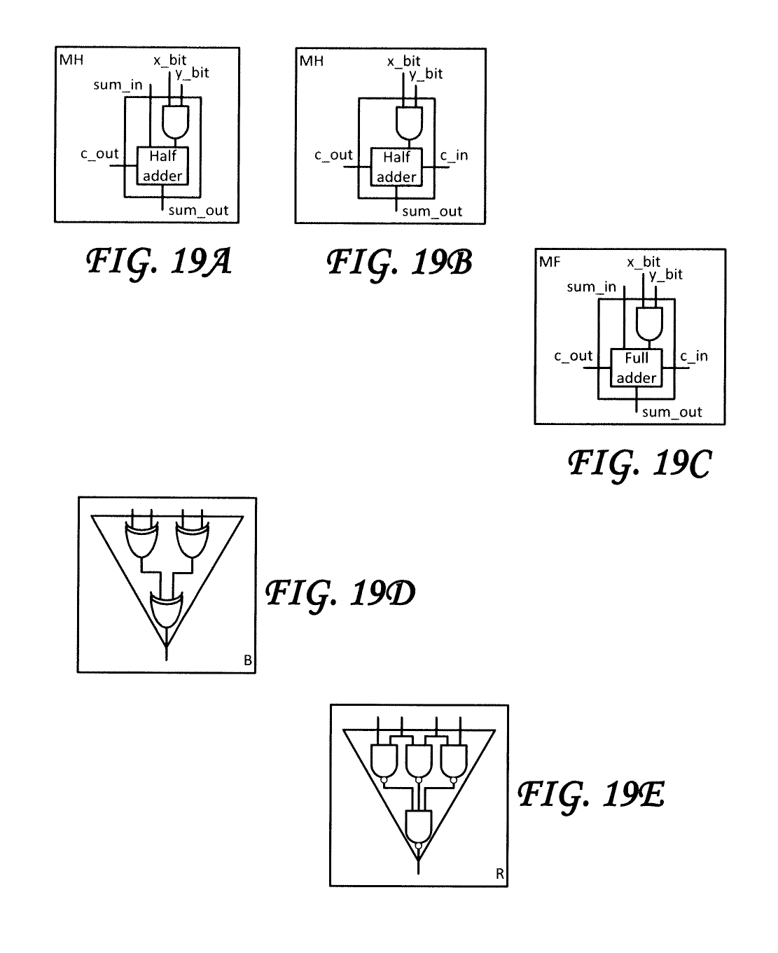

FIG. 18 illustrates an example of how a PUF may be integrated with a multiplier, such that a subset of gates of the multiplier are simultaneously used for computation of multiplications and as part of security primitive PUF. As the multiplier is used for computation, it also participates in producing the PUF output. The PUF output provides proof that a particular computation was indeed performed by the multiplier. In FIG. 18, the triangles including a ‘B’ refer to booster cells, the triangles including an ‘R’ refer to repressor cells, and the blocks including an ‘A’ refer to arbiters. The multiplier block illustrates an example of a multiplier that includes selectable rows and columns of ‘MF’ and ‘MH’ blocks. Examples of ‘MH’ blocks are illustrated in FIGS. 19A and 19B. An example of an ‘MF’ block is illustrated in FIG. 19C. An example of a booster cell is illustrated in FIG. 19D, and an example of a repressor cell is illustrated in FIG. 19E.

The multiplier of FIG. 18 is provided as an illustrative example, and the PUF may be integrated with another arithmetic or logic unit instead. Similarly, PUF circuitry may be integrated with the circuitry of, for example, a sensor or a radio receiver, or in clock circuitry. An attacker cannot alter any part of the system that includes the integrated matched PUF without altering properties of the PUF. For example, delay characteristics of a PUF may be affected by the driving loads of the integration gates.

Using an integrated matched PUF, a variety of security, privacy and trust protocols may be implemented.

One protocol relates to remote trusted sensing. A goal is to design a distributed system of two devices where the first device receives trusted data from the second device. The data is trusted in the sense that the first device can check that the received data is from the second device, and may additionally check that the data is collected at a specific time and a specific location.

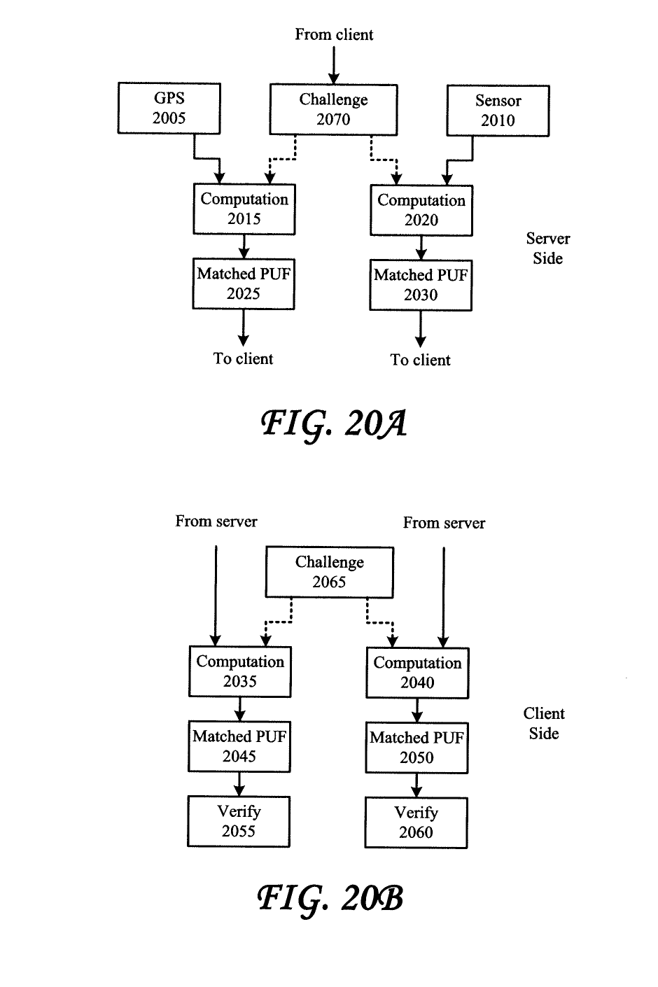

FIGS. 20A and 20B together illustrate an example block diagram for one implementation of a remote trusted sensing protocol on a distributed hardware platform. FIG. 20A represents a server side device, and FIG. 20B represents a client side device. The server side device includes inputs from one or more sensors, such as from a global positioning system (GPS) 2005 and/or one or more sensors 2010. For example, GPS signal data includes indications of location and time of data collection at the server side device. A computation block 2015 and/or 2020 takes as an input the sensor information. A computation block 2015/2020 may be, for example, the multiplier as discussed with respect to FIG. 18. A PUF 2025 or 2030, which in some embodiments is integrated at least in part with the respective computation block 2015/2020, receives the output of the respective computation block 2015/2020, and provides an output to send to the client side device. The server side device sends data collected from sensors 2005/2010 to the client side device along with PUF 2025/2030 output data.

The client device performs a computation 2035 and/or 2040 on the data received from the server side, passes the computation through a corresponding PUF 2045 and/or 2050, and verifies in corresponding block 2055 and/or 2060 that the PUF 2025/2030 output data received from the server side device matches the PUF 2045/2050 output data.

Both the client side and server side devices include substantially identically core hardware. Thus, computation 2015 is substantially identical to computation 2035, computation 2020 is substantially identical to computation 2050, PUF 2025 is substantially identical and matched to PUF 2045, and PUF 2030 is substantially identical and matched to PUF 2050.

Using the described trusted remote sensing protocol, sensors may be remotely monitored with confidence that the received sensor data is provided from the correct remote sensor, and is not invalid data provided from some other source.

A modification of the server/client protocol discussed above for minimizing or preventing replay attack is to add challenges, such that the client side device provides a challenge to the server side device, and the server side device performs a computation with respect to the challenge and the data. More than one challenge may be used in this protocol modification for added security. Challenges are represented by blocks 2065 and 2070 in FIGS. 20B and 20A, respectively.

The technique described for remote sensing may be modified for remote trusted computation. For example, a client side device, such as a smart phone or other computing device, may have restricted energy and computation resources, whereas a server side device such as a data center may have more plentiful resources. The client side device can verify that information received from the server side device is indeed provided by the server side device. Verification may be in real-time or may be off-line, depending on the particular application and the available client side resources. For example, information may be received from the server side device and stored in a memory of the client side device for later verification.

Matched PUFs may further be used for creation of k-anonymity protocols where, for example, the owner of a first PUF proves to the owner of a second PUF that he/she has pertinent credentials in such a way that the proof can also provided by another (k−1) owners of other PUFs.

Thus has been described embodiments of a matched public PUF, an ultra low power cryptographic primitive that enables security protocols such as authentication and public key communication that require only a single clock cycle energy consumption for all participating parties. The PUF is a primitive that leverages parameter variation to facilitate self- and group-reconfigurable public keys. Simulation results show resiliency to a wide variety of security attacks and energy requirements that are orders of magnitude less than other proposed hardware implementations.

Advantages of the described PUF include low energy, delay, and area costs, stability against temperature and voltage variations, and suitability for inexpensive, in-field, and accurate characterization. Advantages of the described PUF further include fast and low-energy configuration for PUF matching, the ability to match arbitrary PUF instances, and indefinite reconfigurability. Advantages of the described PUF further include resiliency against security attacks, intractably large (attacker) simulation time, and low probability of coincidence.

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

As used herein, the term “substantially” is used to describe and account for small variations. When used in conjunction with an event or circumstance, the term can refer to instances in which the event or circumstance occurs precisely as well as instances in which the event or circumstance occurs to a close approximation. For example, the term can refer to less than or equal to ±5%, such as less than or equal to ±4%, less than or equal to ±3%, less than or equal to ±2%, less than or equal to ±1%, less than or equal to ±0.5%, less than or equal to ±0.1%, or less than or equal to ±0.05%.

What is claimed is:

1. A security system, comprising:
a first security primitive including a plurality of first cells, wherein each of the first cells includes at least one first cell logic gate;
a second security primitive including a plurality of second cells corresponding to the plurality of first cells of the first security primitive, wherein each of the second cells includes at least one second cell logic gate;
a first processor function associated with the first security primitive; and
a second processor function associated with the second security primitive;
wherein:
each first cell logic gate of the at least one first cell logic gate corresponds to one second cell logic gate of the at least one second cell logic gate; and
for the each first cell logic gate,
the first processor function is configured to determine a parameter value for the each first cell logic gate and provide the determined parameter value to the second processor function;
the second processor function is configured to compare the determined parameter value of the each first cell logic gate with a parameter value of the corresponding second cell logic gate; and
the second processor function is further configured to provide comparison information to the first processor.

2. The security system of claim 1, wherein the first security primitive and the second security primitive are implemented on a single integrated circuit device, and wherein the first processor function and the second processor function are implemented in one processor.

3. The security system of claim 1, wherein the parameter is propagation delay for a defined combination of inputs, and the parameter value represents time.

4. The security system of claim 1, implemented as a delay quantization system, wherein the parameter value for the each first cell logic gate is a first quantum, assigned based on: a propagation delay of the each first cell logic gate for a defined combination of inputs; and a maximum additional delay due to aging.

5. The security system of claim 4, wherein the comparison information indicates whether a second quantum assigned to the corresponding second cell logic gate matches the first quantum.

6. The security system of claim 1, implemented as a coordinated delay system, wherein the parameter value for the each first cell logic gate is a first propagation delay time, and wherein the comparison information indicates a difference between the first propagation delay time and a second propagation delay time of the corresponding second cell logic gate.

7. The security system of claim 6, further comprising a first configuration mechanism associated with the first security primitive; wherein if the comparison information indicates that the first propagation delay is less than the second propagation delay within a predefined first amount, the first configuration mechanism adjusts a parameter of the each first cell logic gate.

8. The security system of claim 7, further comprising a second configuration mechanism associated with the second security primitive; wherein, if the comparison information indicates that the first propagation delay is greater than the second propagation delay within a predefined second amount, the second configuration mechanism adjusts a parameter of the corresponding second cell logic gate.

9. The security system of claim 6, wherein, if the comparison information indicates that the first propagation delay is less than the second propagation delay by more than a predefined first amount, or the first propagation delay is greater than the second propagation delay by more than a predefined second amount, the first configuration mechanism disables the each first cell logic gate, and the second configuration mechanism disables the corresponding second cell logic gate.

10. A security apparatus, comprising:
a security primitive including:
a plurality of inputs;
at least one output; and
a plurality of paths extending between the plurality of inputs and the at least one output, wherein each path includes a plurality of cells; and
a configuration mechanism that is configured to perform a measurement of a parameter associated with a cell of the plurality of cells, and compare the parameter measurement to a value;
wherein, if the parameter measurement is within a predefined amount of the value, the configuration mechanism is configured to adjust the cell such that a later measurement of the parameter is substantially equal to the value.

11. The security apparatus of claim 10, wherein the value of the parameter is determined at least in part based on a process variation.

12. The security apparatus of claim 10, wherein the value of the parameter is determined at least in part based on an operational condition.

13. The security apparatus of claim 10, further comprising a disable mechanism that is configured to disable at least a portion of at least one of the plurality of cells.

14. The security apparatus of claim 10, wherein the security primitive is a hardware-based public physically unclonable function (PUF), wherein at least one of leakage current or switching energy propagating through the PUF to the at least one output is used to generate information for use in a secure protocol.

15. A security method, comprising:
exchanging information related to delays of logic gates of a plurality of security primitives; and
configuring a first and a second of the plurality of security primitives such that the delays associated with a first subset of logic gates of the first security primitive match the delays associated with a corresponding second subset of logic gates of the second security primitive, for secure communication using the first and second security primitives.

16. The security method of claim 15, further comprising:
configuring the first security primitive and a third of the plurality of security primitives such that the delays associated with a third subset of logic gates of the first security primitive match the delays associated with a corresponding fourth subset of logic gates of the third security primitive, for secure communication between the first and third security primitives; and
switching the configuration of the first security primitive in one clock cycle between the configuration for secure communication with the second security primitive and the configuration for secure communication with the third security primitive.

17. The security method of claim 15, wherein at least one of the first and second security primitives is physically integrated into a computational block, wherein the computational block is one of a computational logic block, a clock block, or a global positioning system (GPS) interface block.

18. The security method of claim 15, wherein the secure communication between the first and second security primitives is used for remote trusted sensing.

19. The security method of claim 15, wherein the secure communication between the first and second security primitives is used for remote trusted computing.

20. The security method of claim 15, wherein each of the plurality of security primitives provides a primitive output, and at least two of the primitive outputs are logically combined in an exclusive OR circuit for increased security.
